(19) United States
(12) Patent Application Publication
(10) Pub. No.: US 2011/0140992 A1
(43) Pub. Date: Jun. 16, 2011

(54) LED display

(75) Inventor: Zhongliang Zheng, Hangzhou (CN)

(73) Assignee: Isign display systems LLC (Hangzhou)

(21) Appl. No.: 12/639,047

(22) Filed: Dec. 16, 2009

(51) Int. Cl. G09G 5/00

(52) U.S. Cl. 345/1.3; 345/690; 345/82; 345/698

(57) ABSTRACT

A LED display includes a plurality of LED units connected together; a plurality of unit controller connected one after another mounted to the plurality of LED units respectively, wherein each unit controller comprises a direction setup element, indicating position relationship with next connected unit controller, wherein the direction setup element is set up during physical connection of the unit controller; and a main controller, connected with each unit controller, determining position of each LED unit in the LED display via the position relationship information set up by the direction setup element.

### BACKGROUND OF THE PRESENT INVENTION

1. Field of Invention

The present invention relates to a LED display formed by a plurality of standard LED units, and more particularly to LED display that can automatically position each LED unit so as to determine the range of the receiving data of each LED unit,

2. Description of Related Arts

LED displays are widely used in various situations, such as stadiums, malls, airports, casinos, and stages. Different sizes of LED display are needed for different situations, which bring trouble to the LED display maker. Therefore, LED display formed by a plurality of standard LED units is developed. Each LED unit will display part of data of the LED display according to the position of each LED unit. In order to determine the range of the receiving data of each LED unit, the position of each LED unit has to be known. Therefore, how to position each LED unit in the LED display becomes a vital problem.

The conventional positioning method has to be implemented by professional workers. The professional worker sets up the position of each LED unit in software according to the real position of each LED unit of LED display, determines the connecting relationship of each LED units, and sets up other basic information such as color, LED parameters as so on. The configured file is then saved and sent to each unit controller of each LED unit to determine the range of receiving data of each LED unit. Such method has several drawbacks: first, professional worker is required; second, configured file may be lost; third, when a LED unit or its unit controller is replaced, the configured file has to be reconfigured.

### SUMMARY OF THE PRESENT INVENTION

An object of the present invention is to provide a LED display having a plurality of LED units that can be automatically positioned, wherein a direction setup element is configured to each LED unit to show the position relationship of two connected LED units, so that each LED unit can be positioned.

Another object of the present invention is to provide a LED display having a plurality of LED units that can be automatically positioned, wherein each LED unit comprises a plurality of display modules having an input port to communicate with a plurality output ports of a unit controller, wherein each display module communicate with a output port of the unit controller in corresponding position.

Another object of the present invention is to provide a LED display having a plurality of LED units that can be automatically positioned, wherein each LED unit comprises a plurality of display modules, each display module comprises a memory for storing a resolution ratio, color and LED parameters of the display module.

Another object of the present invention is to provide a LED display having a plurality of LED units that can be automatically positioned by a control system without manual operation.

Accordingly, in order to accomplish the above objects, the present invention provides a LED display comprising:

a plurality of LED units connected together;

a plurality of unit controller connected one after another mounted to the plurality of LED units respectively, wherein each unit controller comprises a direction setup element, indicating position relationship with next connected unit controller, wherein the direction setup element is set up during physical connection of the unit controller; and

a main controller, connected with each unit controller, determining position of each LED unit in the LED display via the position relationship information set up by the direction setup element.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a LED display according to a preferred embodiment of the present invention.

FIG. 2 is a perspective view of a plurality of display module of each LED unit and a unit controller of the LED display according to the above preferred embodiment of the present invention.

### DETAILED DESCRIPTION OF THE PREFERRED EMBODIMENT

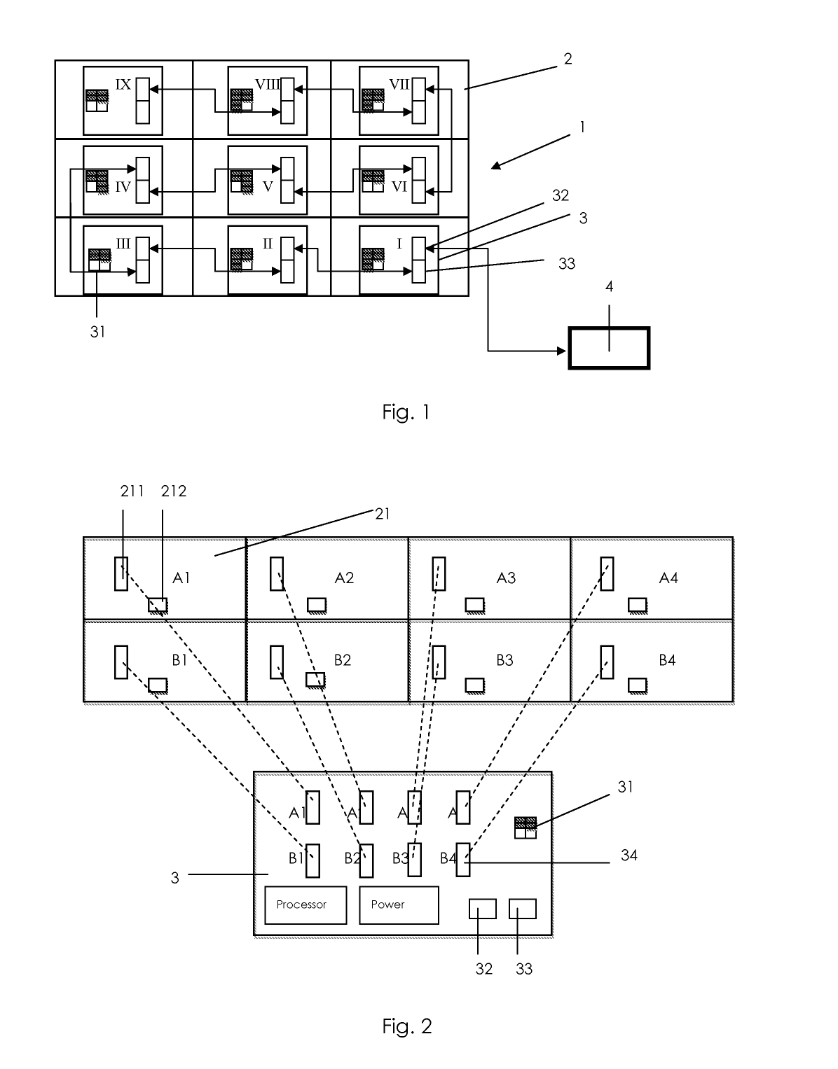

Referring to FIG. 1 of the drawings, a LED display 1 according to a preferred embodiment of the present invention is illustrated, in which the LED display 1 is formed by a plurality of connected LED units 2. Each LED unit 2 is configured with unit controller 3. The unit controllers are connected one after another. Each unit controller comprises a direction setup element 31 indicating position relationship with next connected unit controller, wherein the direction setup element is set up during physical connection of the unit controller. A main controller 4 is connected with each unit controller 3, which can determine position of each LED unit 2 in the LED display 1 via the position relationship information set up by the direction setup element 31.

As shown in FIG. 1, the LED display 1 in this preferred embodiment is formed by nine connected LED units 2. The unit controllers 3 configured to LED units Ito IX are connected one after another as shown by arrows in FIG. 1. The unit controller II is on left of the unit controller I, the direction setup element of the unit controller I is set up to “left”; The unit controller III is on left of the unit controller II, the direction setup element of the unit controller II is set up to “left”; The unit controller IV is above the unit controller III, the direction setup element of the unit controller III is set up to “above”; The unit controller V is on right of the unit controller IV, the direction setup element of the unit controller IV is set up to “right”; The unit controller VI is on right of the unit controller V, the direction setup element of the unit controller V is set up to “right”; The unit controller VII is above the unit controller VI, the direction setup element of the unit controller VI is set up to “above”; The unit controller VIII is on left of the unit controller VII, the direction setup element of the unit controller VII is set up to “left”; The unit controller IX is on left of the unit controller VIII, the direction setup element of the unit controller VIII is set up to “left”.

The main controller is connected to the unit controller I, and then connected to each unit controller via the connection between the unit controllers. As shown in FIG. 2, each unit controller has a signal input 32 and a signal output 33, the signal input of the unit controller I is connected with the main controller, and the signal output of the unit controller I is connected with the signal input of the unit controller II. The signal input of the rest unit controller is connected with the previous unit controller, the signal output is connected with the next unit controller, and the signal output of the last unit controller is idle. The main controller 4 inquires each unit controller 3 the position relationship with next unit controller, and each unit controller 3 feed back the information. The main controller calculates the position of each unit controller according to the position relationship information of each unit controller, and then calculates the range of receiving data of each unit controller, such as from what column and row to what column and row.

Referring to FIG. 2 of the drawings, the direction setup element 31 is embodied as a 2 position DIP switch. The four combinations of the 2 position DIP switch of the unit controller represent the 4 possible directions of the next unit controller with respect to the present unit controller, such as left, right, up and down. The 2 position DIP switch is set up during the physical connection of the unit controller. The unit controller determines the position relationship between the present unit controller and the next unit controller connected with the present unit controller, and sent the information to the main controller. The main controller 4 informs each unit controller the range of receiving data, and each unit controller display the range of receiving data on the LED unit.

Further referring to FIG. 2 of the drawings, each LED unit 2 comprises a plurality of, such as 8, display modules 21 connected together. Each display module has an input interface 211. Each unit controller has a plurality of output interface 34, such as 8, connected with the input interfaces of the plurality of display modules. The output interface 34 of the unit controller is connected to the display module of corresponding places, as shown in FIG. 2. Via the output interfaces 34 communicated with the module display, the unit controller 3 can determine the numbers of display module that connected with the unit controller, and the numbers of transverse LED and vertical LED.

Each display module comprises a memory 212, storing the resolution ratio, color and LED parameters of the display module. The main controller 4 inquires each unit controller 3 the resolution ratio, color and LED parameters of the LED unit, and position relationship with the connected next unit controller. Then each unit controller feeds back such information to the main controller. The main controller can calculate the position of each LED unit according to the information and the range of receiving data of each unit controller. Then the main controller informs each unit controller the range of receiving data of each unit controller, and each unit controller display data according the range of receiving data. From the above steps, the system can automatically position each LED unit without manual operation. Changing unit controller and display module does not affect the positioning. Therefore, according to the present invention, the cost can be greatly saved, and the workload is substantially reduced. Furthermore, the present invention is easy to operate and manage.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A LED display, comprising:
a plurality of LED units connected together;
a plurality of unit controller connected one after another mounted to the plurality of LED units respectively, wherein each unit controller comprises a direction setup element, indicating position relationship with next connected unit controller, wherein the direction setup element is set up during physical connection of the unit controller; and
a main controller, connected with each unit controller, determining position of each LED unit in the LED display via the position relationship information set up by the direction setup element.

2. The LED display, as recited in claim 1, wherein the direction setup element is embodied as a 2 position DIP switch having four combinations representing four possible directions of the next unit controller with respect to the present unit controller, including left, right, up and down.

3. The LED display, as recited in claim 1, wherein each unit controller has a signal input and a signal output, the signal input of the first unit controller is connected with the main controller, the signal input of the rest unit controller is connected with the signal output of the previous connected unit controller, and the signal output of the last unit controller is idle.

4. The LED display, as recited in claim 2, wherein each unit controller has a signal input and a signal output, the signal input of the first unit controller is connected with the main controller, the signal input of the rest unit controller is connected with the signal output of the previous connected unit controller, and the signal output of the last unit controller is idle.

5. The LED display, as recited in claim 1, wherein each LED unit comprises a plurality of display modules connected together, each display module having an input interface, and each unit controller has a plurality of output interface connected with the input interfaces of the plurality of display modules respectively.

6. The LED display, as recited in claim 2, wherein each LED unit comprises a plurality of display modules connected together, each display module having an input interface, and each unit controller has a plurality of output interface connected with the input interfaces of the plurality of display modules respectively.

7. The LED display, as recited in claim 5, wherein each display module comprises a memory, storing the resolution ratio, color and LED parameters of the display module.

8. The LED display, as recited in claim 6, wherein each display module comprises a memory, storing the resolution ratio, color and LED parameters of the display module.

9. The LED display, as recited in claim 7, wherein the main controller inquires each unit controller information of resolution ratio, color and LED parameters of the LED unit, and position relationship with the connected next unit controller; then each unit controller feeds back such information to the main controller; the main controller calculates position of each LED unit according to the information and range of receiving data of each unit controller; then the main controller informs each unit controller the range of receiving data of each unit controller, and each unit controller displays data according range of receiving data.

10. The LED display, as recited in claim 8, wherein the main controller inquires each unit controller information of resolution ratio, color and LED parameters of the LED unit, and position relationship with the connected next unit controller; then each unit controller feeds back such information to the main controller; the main controller calculates position of each LED unit according to the information and range of receiving data of each unit controller; then the main controller informs each unit controller the range of receiving data of each unit controller, and each unit controller displays data according range of receiving data.
